(19) United States
(12) Patent Application Publication
(10) Pub. No.: US 2008/0172251 A1
(43) Pub. Date: Jul. 17, 2008

(54) Clinical Cost Control Management Module

(75) Inventors: Helge Reichert, Berlin (DE); Sebastian Baer, Munich (DE); Alexander Schuetz, Forchheim (DE); Robin Fischer, Muenster (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 12/013,530

(22) Filed: Jan. 14, 2008

Related U.S. Application Data
(60) Provisional application No. 60/885,022, filed on Jan. 16, 2007.

(51) Int. Cl. G06Q 50/00

(52) U.S. Cl. 705/2

(57) ABSTRACT

A system enables a healthcare organization to evaluate cost efficient treatment options early in a patient treatment process by automatic monitoring of profit or loss of a treatment, in real-time and enables a clinical user to screen, simulate and control treatment profit or loss during a patient visit, based on both expected reimbursement and the actual costs of performed services. A system enables cost based treatment selection by providing a healthcare worker with patient specific treatment cost information during a treatment episode. An acquisition processor automatically interrogates at least one information repository for data concerning cost to a healthcare organization of providing a proposed treatment to a patient and expected cost reimbursement to the healthcare organization for the proposed treatment. The acquisition processor initiates generation of at least one message including a patient identifier and treatment identification code for communication to the at least one information repository, in response to data indicating occurrence of a treatment related event. A display processor initiates generation of data representing at least one display image including information indicating the proposed treatment is unprofitable for the healthcare organization.

This is a non-provisional application of provisional application Ser. No. 60/885,022 filed Jan. 16, 2007, by H. Reichert et al.

### FIELD OF THE INVENTION

This invention concerns a system enabling cost based treatment selection by providing a healthcare worker with patient case specific treatment cost information and indicating a proposed treatment may be unprofitable for a healthcare organization, for example.

### BACKGROUND OF THE INVENTION

In healthcare organizations that operate as profit centers, the profitability of an organization is based on a cost and reimbursement calculation. Healthcare organizations costs consist usually of fixed costs (e.g., staff salaries) and single service based costs. A cost calculation for an entire healthcare organization as well as for a single visit is often performed by a separate Enterprise Resource Planning System. Cost control is one of the significant functions of such a system. Known Clinical Information Systems typically do not track cost information and do not provide cost information to clinical users. Therefore, these systems offer limited integration of clinical and financial data flows. Known systems in the clinical environment typically do not comprehensively integrate clinical and financial workflows and data and do not provide workflow and process management, with cost information, in the clinical environment and do not support overall real-time workflow monitoring and management.

Known clinical cost management systems fail to provide display of real-time calculated costs per patient visit to a clinical user as part of a clinical workflow and do not provide a visit based cost-object in comparison with expected reimbursement for the same patient visit to the clinical user. Known systems also fail to provide automated monitoring and management of a cost and reimbursement calculation by a Workflow Management System using input data derived from a Clinical Information System as well as an Enterprise Resource Planning System. Further, known systems do not support active alerting in suggesting actions and options and fail to provide a cost/treatment simulation in an early stage of a treatment process. The retrospective collection of data from different sources in known systems is labor intensive and fails to support adjustment of patient treatment during a stay of the patient. A system according to invention principles addresses these deficiencies and related problems.

### SUMMARY OF THE INVENTION

A system enables a healthcare organization to evaluate cost efficient treatment options early in a patient treatment process by automatic monitoring of profit or loss of a treatment, in real-time and notifies a user of a Clinical Information System if a profit or loss exceeds an adjustable threshold and also suggests cost efficient treatment options compliant with clinical guidelines. A system enables cost based treatment selection by providing a healthcare worker with patient specific treatment cost information during a treatment episode. An acquisition processor automatically interrogates at least one information repository for data concerning cost to a healthcare organization of providing a proposed treatment to a patient and expected cost reimbursement to the healthcare organization for the proposed treatment. The acquisition processor initiates generation of at least one message including a patient identifier and treatment identification code for communication to the at least one information repository, in response to data indicating occurrence of a treatment related event. A display processor initiates generation of data representing at least one display image including information indicating the proposed treatment is unprofitable for the healthcare organization.

### BRIEF DESCRIPTION OF THE DRAWING

FIG. 1 shows a cost based treatment selection system, according to invention principles.

FIG. 2 shows a cost based treatment selection system overview, according to invention principles.

FIG. 3 shows a cost based treatment selection system workflow task sequence, according to invention principles.

FIG. 4 shows functional operation of the cost based treatment selection system, according to invention principles.

FIG. 5 shows a user interface display image presenting a worklist of a worker, according to invention principles.

FIG. 6 shows a user interface display image illustrating suggested treatment alternatives, according to invention principles.

FIG. 7 illustrates integration of a cost based treatment selection system workflow task sequence in a clinical workflow, according to invention principles.

FIG. 8 shows a user interface display image presenting profit/loss data, according to invention principles.

FIG. 9 shows a flowchart of a process performed by a cost based treatment selection system, according to invention principles.

### DETAILED DESCRIPTION OF THE INVENTION

### Definitions

A Hospital Information System (HIS) is a computer system for managing hospital medical and administrative information and combines clinical, administrative and financial components in order to enable healthcare professional to deliver healthcare effectively and efficiently.
A Clinical Information System (CIS) captures and stores patient clinical data, provides access to clinical information to employees in a healthcare provider organization and allows users to order services and record the results. A CIS typically supports Clinical Documentation, Clinical Order Management, Electronic Medical Records as well as employee, service and resource Scheduling and Financial Information and Administration Systems.
A Financial information and administration systems (FIS) is a computer system that manages business operation of a hospital and is comprised of one or more applications for any of the following: collecting, processing, maintaining, transmitting, and reporting data about financial events; supporting financial planning or budgeting activities; accumulating and reporting cost information; or supporting the preparation of financial statements. In some environments it supports patient administration with case management and location management (these may be integrated within a CIS) and supports Hospital Financial information, Patient Financial information and Accounting
An Enterprise Resource Planning (ERP) system is used to manage company resources and functions including Purchasing, Supply Chain Planning and Execution, Accounting/Controlling, Human Resources and Sales.
A Diagnosis Related Group (DRG) comprises a payment category used to classify patients and especially Medicare patients for the purpose of reimbursing hospitals for each case in a given category with a fixed fee regardless of the actual costs incurred. Categories are based especially on the principal diagnosis, surgical procedure used, age of patient, and expected length of stay in a hospital.
A DRG-Grouper uses “principal diagnosis, secondary diagnoses, surgical procedures, age, sex and discharge status of the patients treated” (DRG Definitions Manual, 1994) to assign inpatient records to a specific DRG.
A Cost Object is the sum of basic general costs and service-based costs being performed for a given visit of a patient and is the basis for a bill.
Admission-Discharge-Transfer (ADT) events and related data are part of patient administration from admission via transfer to discharge of a patient.
A Contract Management System assists in calculating complex expected payments, reconciles expected payments with actual payments and communicates variances to an insurance carrier.

The inventors have advantageously recognized that there is a need for a computerized system capable of monitoring cost information from a Financial Information and Administration System and Enterprise Resource Planning System in comparison with reimbursement information. The system thereby supports a healthcare user of a Clinical Information System in performing tasks in daily operation by defining, processing and filtering the cost information. The management of these data sources from different connected systems involves accumulating, processing and maintaining large quantities of information. A workflow processor uses the different data sources to retrieve processed information and to provide this information to a user. Information is made available in a clinical workflow process in an automated manner enabling a clinical user to make the right decision considering cost factors.

The system addresses different problems that are associated with integration of billing workflows with a clinical workflow and optimizes cost-sensitive treatment of patients in a healthcare environment and improves the accuracy of clinical coding and documentation. The system saves time in patient care, especially in the regions of the world where coding for billing purposes (as well as treatment) is performed by clinicians. The system provides automated monitoring of cost-related data from different sources for use in a clinical environment and displays relevant data to support informed treatment decisions to improve patient treatment.

A system and workflow (task sequence performed by device and worker) supports a clinical process by providing cost control functions and cost reimbursement information for monitoring operation of a Clinical Information System. The system enables a clinical user to screen, simulate and control profit and loss occurring during a patient visit, depending on an expected treatment service reimbursement and actual cost of performed services. The system advantageously enables a healthcare organization to evaluate cost efficient treatment options early in a treatment process. Hence, it facilitates increasing profitability of hospitals. The system and workflow automatically monitors profit and loss occurring in real-time and notifies users of Clinical Information Systems that profit or loss exceeds an adjustable profit threshold. Furthermore, the system suggests cost efficient treatment options compliant with clinical guidelines.

The system employs accumulated and individual item cost information (e.g., derived from a Financial Information and Administration System and Enterprise Resource Planning System) to generate profitability parameters used to influence treatment decisions made by a clinical user in patient treatment. In hospital facilities clinical users are typically responsible for controlling costs affecting hospital profitability. A clinician needs to ensure that the right services and treatment are provided to a patient. The earlier in a treatment process that estimated reimbursement information is determined, the more efficient the process of making treatment decisions becomes as it facilitates adjustment of treatment alternatives and cost-saving diagnostics and treatment options. The integration of financial and clinical information into a clinical system supports display of expected reimbursement cost data as well as relative cost information for ordered treatment items and services that is not just specifically related to a patient visit or for comparison with actual reimbursed cost data (e.g., in conjunction with DRGs (diagnosis related groups) and data from service based billing systems and Contract Management Systems).

A processor, as used herein, operates under the control of an executable application to (a) receive information from an input information device, (b) process the information by manipulating, analyzing, modifying, converting and/or transmitting the information, and/or (c) route the information to an output information device. A processor may use, or comprise the capabilities of, a controller or microprocessor, for example. The processor may operate with a display processor or generator. A display processor or generator is a known element for generating signals representing display images or portions thereof. A processor and a display processor may comprise a combination of, hardware, firmware, and/or software.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A user interface (UI), as used herein, comprises one or more display images, generated by a display processor and enabling user interaction with a processor or other device and associated data acquisition and processing functions.

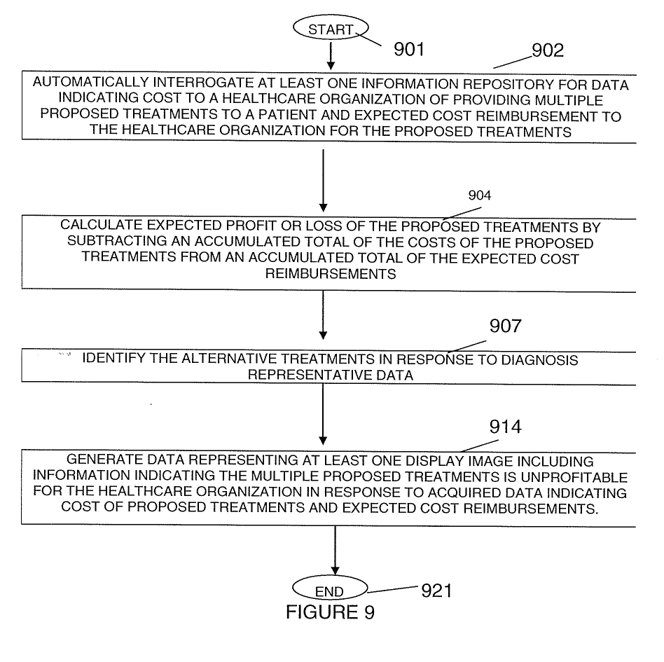

The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application, manipulates the UI display images in response to signals received from the input devices. In this way, the user interacts with the display image using the input devices, enabling user interaction with the processor or other device. The functions and process steps (e.g., of FIG. 9) herein may be performed automatically or wholly or partially in response to user command. An activity (including a step) performed automatically is performed in response to executable instruction or device operation without user direct initiation of the activity. Workflow comprises a sequence of tasks performed by a device or worker or both. An object or data object comprises a grouping of data, executable instructions or a combination of both or an executable procedure.

A workflow processor, as used herein, processes data to determine tasks to add to a task list, remove from a task list or modifies tasks incorporated on, or for incorporation on, a task list. A task list is a list of tasks for performance by a worker or device or a combination of both. A workflow processor may or may not employ a workflow engine. A workflow engine, as used herein, is a processor executing in response to predetermined process definitions that implement processes responsive to events and event associated data. The workflow engine implements processes in sequence and/or concurrently, responsive to event associated data to determine tasks for performance by a device and or worker and for updating task lists of a device and a worker to include determined tasks. A process definition is definable by a user and comprises a sequence of process steps including one or more, of start, wait, decision and task allocation steps for performance by a device and or worker, for example. An event is an occurrence affecting operation of a process implemented using a process definition. The workflow engine includes a process definition function that allows users to define a process that is to be followed and includes an Event Monitor, which captures events occurring in a Healthcare Information System. Event examples include patient admission, start of documentation and ordering a medication. A processor in the workflow engine tracks which processes are running, for which patients, and what step needs to be executed next, according to a process definition and includes a procedure for notifying clinicians of a task to be performed, through their worklists (task lists) and a procedure for allocating and assigning tasks to specific users or specific teams. The processor supports user performance of tasks as well as documenting task completion and or indicating why a task was not performed. Further, a document or record comprises a compilation of data in electronic form and is the equivalent of a paper document and may comprise a single, self-contained unit of information.

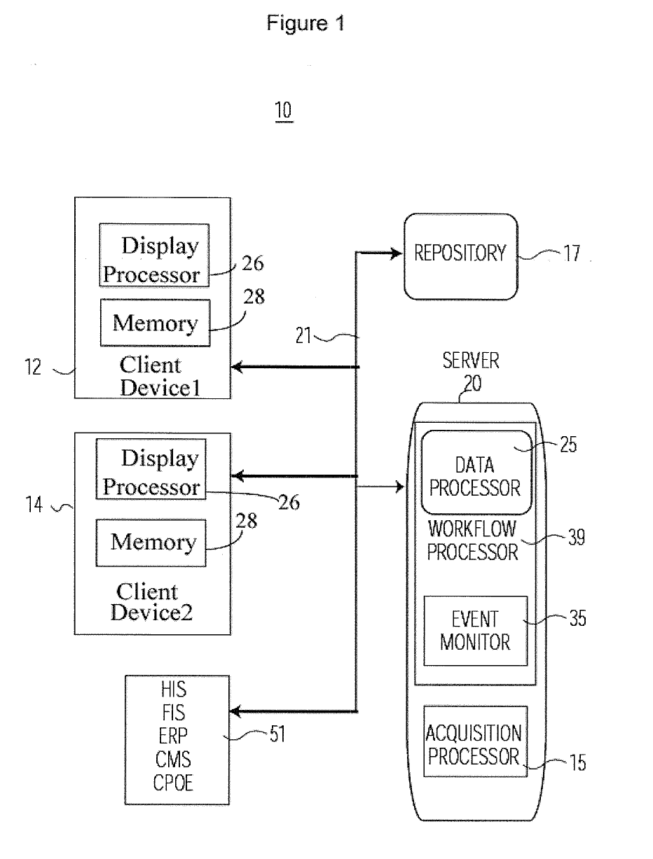

FIG. 1 shows cost based treatment selection system 10 enabling cost based treatment selection by providing a healthcare worker with patient specific treatment cost information during a treatment episode. Cost based treatment selection system 10, includes client devices (workstations) 12 and 14, repository 17, Financial Information System, Enterprise Resource Planning System, Contract Management System, Computerized Order Entry System (CPOE) and a Clinical Information System (collectively 51) and server 20 inter-communicating via network 21. Workstations (client devices) 12 and 14 individually include memory 28 and display processor 26. Acquisition processor 15 automatically interrogates repository 17 for data concerning cost incurred by a healthcare organization of providing a proposed treatment to a patient and expected cost reimbursement to the healthcare organization for the proposed treatment. Acquisition processor 15 initiates generation of at least one message including a patient identifier and treatment identification code for communication to information repository 17, in response to data indicating occurrence of a treatment related event detected by event monitor 35 of workflow processor 39. The treatment related event comprises entry of data indicating the proposed treatment via a computerized treatment order entry system (unit 51), a change in level of care of the patient or a change in, or creation of, a treatment plan for the patient.

Display processor 26 initiates generation of data representing at least one display image for presentation on workstation 12 and 14 including information indicating the proposed treatment is unprofitable for the healthcare organization. A display image also includes information indicating alternative treatments to the proposed treatment. The alternative treatments comprise treatments that are more profitable for the healthcare organization. The information indicating the proposed treatment is unprofitable for the healthcare organization is presented in a composite image together with data identifying a treatment order for the proposed treatment provided by the computerized order entry system.

Data processor 25 is integrated within workflow processor 39 and with HIS 51 and calculates estimated cost and reimbursement for a particular patient treatment and provides projected profit (or loss) data for the particular treatment plan. Data processor 25 performs real-time estimation of, costs that a healthcare organization will incur while treating a specific patient and reimbursement that the healthcare organization will receive from insurance (or other sources) for treating this patient. Data processor 25 further compares estimated cost with estimated reimbursement in providing data indicating expected profit/loss of a patient treatment (or visit) and suggests alternative less expensive treatment options to a healthcare provider in order to improve profitability or reduce loss. Further, in one embodiment, system 10 is integrated with business processes of a healthcare organization to facilitate clinician control and management of profit/loss of a patient hospital visit. System 10 provides the cost, profit/loss and alternative treatment information to a Clinical Information System enabling a clinician to evaluate cost-saving treatment options compliant with treatment guidelines of a healthcare organization and improves the accuracy of coding/billing documentation.

Data processor 25 operating with display processor 26, provides one or more display images including, cost information for services to be performed in a clinical workflow, accumulated costs per visit of a patient including a listing of fixed costs as well as variable costs for performed services and a cost-object compared with expected reimbursement per visit identifying a difference. Further, data processor 25 and display processor 26 provide real-time availability of information in an image (e.g., costs, reimbursement, alternatives) and provides a simulation indicating an effect of a planned service (ordered treatment service), on a cost-object and therefore on cost or reimbursement calculation. Thereby system 10 improves accuracy of clinical coding and documentation and automatically suggests cost-saving treatment alternatives. System 10 integrates workflow processor 39 with system 51 including a Financial Information System, an Enterprise Resource Planning System and a Clinical Information System. System 10 supports creation and modification of a comprehensive clinical cost structure and is able to track patient visit related costs in comparison with expected reimbursement information and identify possible alternatives based on the input from different data sources. Workflow processor 39 optimizes a financial position of a healthcare organization, in response to a Process Definition that determines actions that need to be taken for a patient with a negative (loss) projection result, according to a DRG reimbursement/service costs comparison.

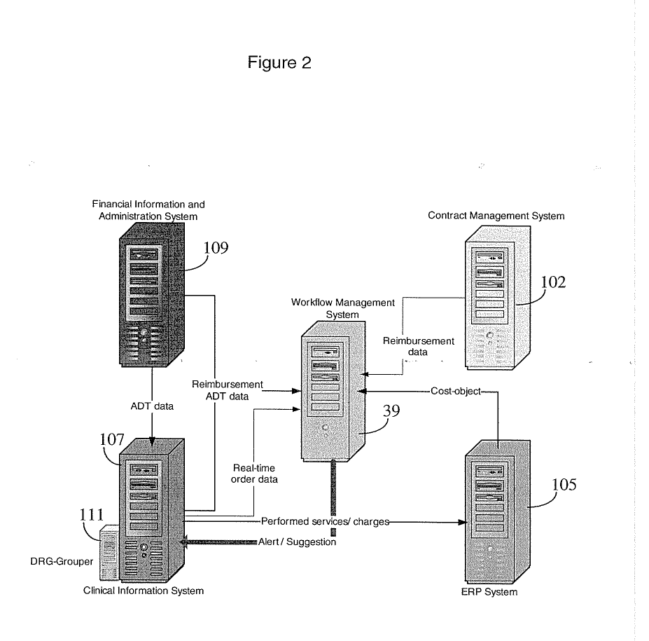

FIG. 2 shows a cost based treatment selection system overview illustrating different data sources (Systems) involved and associated data exchange. The FIG. 2 system includes Financial Information and Administration System 109 that stores ADT data of a patient, Enterprise Resource Planning System 105 that creates and stores a cost object for a particular patient visit, which is updated with data indicating performed services/charges of CIS 107. Further CIS 107 incorporates DRG-Grouper unit 111 used to determine a particular reimbursement for a particular patient in response to ADT data received from Financial Information and Administrative System 109. Contract Management System (CMS) 102 stores contract related billing information and workflow processor 39 acquires different data from the systems involved to simulate and display profit/loss. Also, ADT data is provided by Financial Information and Administration System 109 and CIS 107. Reimbursement data is either provided by system 109 and CIS 107 or Contract Management system 102. Cost related data for performed services and charges is provided by ERP System 105 in the form of a patient visit specific cost-object. Workflow processor 39 including data processor 25, processes the information provided by units 102, 105, 107 and 109 to calculate a current profit/loss state for a treatment or visit, for example. Workflow processor 39 processes real-time order data, provided by CIS 107 in performing real-time simulation that extrapolate cost of treatment, even before services are performed. This enables workflow processor 39 to alert a user of CIS 107 of a projected loss for a treatment and initiates processor 39 to suggest a more cost efficient treatment option (if any) that is compliant with treatment guidelines of a healthcare organization.

Desired cost information is identified based on an individual treatment service item name since an individual treatment service item has a discrete value, and named cost and this is derived by accessing an associated cost object. The cost information is used to determine profitability by computing a total cost of items that have been ordered in a patient visit, for example. The cost is subtracted from the pre-defined total expected reimbursement amount determined based on a contract between a healthcare provider organization and payer organization. The expected reimbursement amount is associated with a DRG and maintained in a DRG object and is modified in response to contract changes between a healthcare provider organization and payer organization.

Workflow processor 39 processes real-time order data indicating orders a user places by selecting services from a displayed order menu in a computerized order entry (CPOE) system. The selected services are identified in an order service master file. An individual service has a unique identification number and one or more items that make up the service. Individual service items (service objects) have an identification number and exist in an order services master file. An individual service object has multiple characteristics that further define and restrict it, such as, a short literal description, a monetary charge value ($xx,xxx.xx), a monetary cost value ($xx,xxx.xx), a unit of order (xxxx.xxx), for example. A Service object is initialized and maintained and comprises order policies of a healthcare organization, and maintenance is achieved using a process for authorized IT personnel to maintain object integrity. When an order is placed, the service objects associated with the order are assigned to a patient object record so that a complete list of orders and Services (service objects) are maintained. Data processor 25 sums the monetary value of the services for a patient to derive a total value that is subtracted from a contract determined reimbursement amount. If the total value is less than the reimbursement amount, the order may be processed. If the total value is greater than the reimbursement amount, a user is notified and prompted for a different order selection that is less costly but still clinically effective.

System 10 stores the costs of individual treatment services in a Service Catalog in repository 17 and data processor 25 calculates the cost of charges for individual Services. Data processor 25 queries a Service Catalog to acquire costs related to a patient encounter and sums costs to obtain a cumulative cost. The costs are also displayed in a UI image by display processor 26. The system determines what cost information is requested based on at least one of, physician or user entered data for a certain time line, a number of orders and a current encounter. In one embodiment the system in response to a query, determines fixed and variable costs related to a current encounter of an inpatient. A reimbursement function calculates expected reimbursement related to an inpatient encounter based on cost and/or price and uses the reimbursement it receives, e.g., through association with a DRG and displays it in a display image.

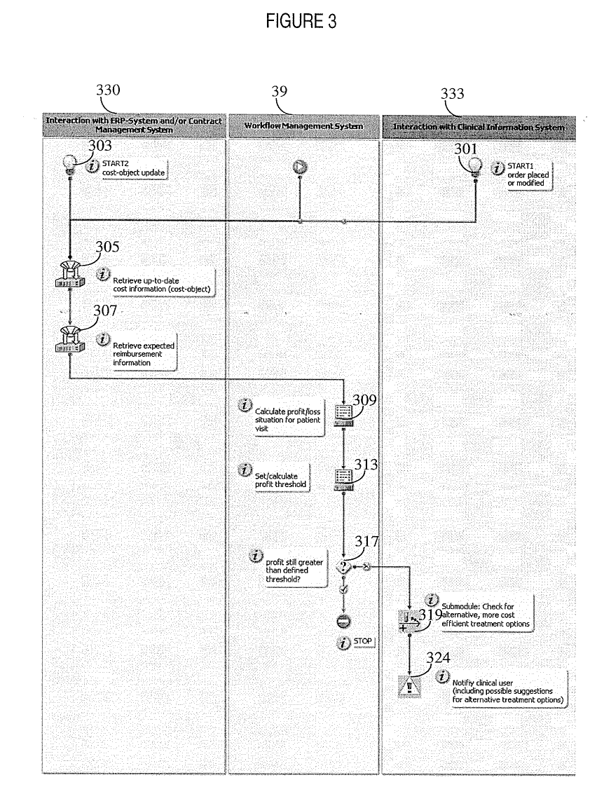

FIG. 3 shows a cost based treatment selection system workflow task sequence 340 performed by workflow processor 39 interacting (330) with an ERP and CMS and interacting (333) with a CIS. An automated monitor process performed by workflow processor 39 (FIG. 1) triggers a workflow in response to system events. The workflow process 340 of FIG. 3 starts in response to a place/modify order event 301 created by a CIS or in response to an event 303 created by an ERP System indicating that a cost-object for a patient visit has been changed. In step 305 workflow processor 39 acquires real-time cost information for a particular treatment or visit by initiating a service which retrieves a cost-object from an ERP System. Workflow processor 39 uses an Enterprise Application Integration (EAI) process to access the service as well as to access a further service in step 307 to acquire reimbursement information for the particular treatment or visit. The acquired cost and reimbursement information is used by data processor 25 in step 309 to calculate a current profit/loss projection of a healthcare organization for providing the particular treatment or hosting the patient visit. In step 317, data processor 25 determines whether the projected profit exceeds a customizable profit threshold set or calculated in step 313. Workflow processor 39 notifies a user of a Clinical Information system in step 324 if the profit falls below the customizable profit threshold. However, before the user is notified, workflow processor 39 in step 319 automatically searches repository 17 for alternative treatment options. A workflow processor 39 sub-module uses clinical information, e.g., diagnosis identifier and order and result data, to determine candidate treatment alternatives compliant with healthcare organization specific requirements. In response to alternatives being identified, workflow processor 39 notifies the user of the Clinical Information System that the profit falls below the customizable profit threshold and suggests alternative, more cost efficient candidate treatments prior to termination of the FIG. 3 process. If it is determined in step 317 that the current profit/loss projection exceeds the customizable profit threshold no action is taken and the process of FIG. 3 terminates.

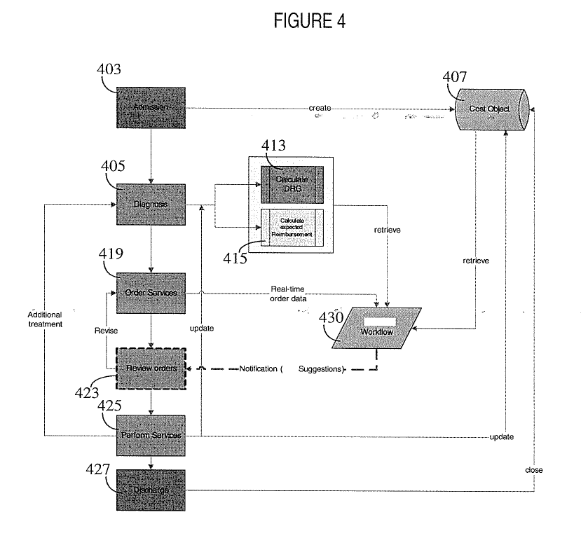

FIG. 4 shows functional operation of cost based treatment selection system 10 (FIG. 1) and illustrates interaction with the different systems of a healthcare organization indicated in FIG. 2 to improve the cost efficiency of treatment during a patient visit. In an example of operation, a 57 years old, male patient is taken to an Emergency room (ER) and admitted to a hospital in step 403 with shortness of breath, fatigue and reduced exercise tolerance. A cost-object 407 for the patient visit is created in the ERP System. A patient physical examination and other service is performed in step 405 including examination of heart, skin, lung and abdomen which is unremarkable, however the patient has peripheral edema on both legs for which a previous medication has been prescribed as recorded by data entered into the clinical information system. Diagnosis data acquired in step 405 is used in steps 413 and 415 to calculate an expected reimbursement for a treatment for the condition identified by the diagnosis and DRG, Alternatively or additionally, a more complex service reimbursement may be determined using a Contract Management System.

Workflow processor 39, using acquisition processor 15, automatically interrogates at least one information repository 17 for data concerning cost incurred by a healthcare organization of providing a proposed treatment to a patient and expected cost reimbursement to the healthcare organization. For this purpose, a patient is registered in a financial system and information is exchanged with a clinical information system and one or more diagnoses are assigned to the patient at time of admission, for example. In this case, the patient is admitted with suspected congestive heart failure (CHF). CHF has multiple symptoms: shortness of breath, fatigue and reduced exercise tolerance, peripheral edema on both legs. The admitting diagnosis is entered as ICD9 code 402.91, hypertensive heart disease, unspecified with congestive heart failure. A clinical information system in step 413 calculates a DRG using a look-up table since CHF is classified as DRG 194 (Diagnosis Related Group 194), heart failure. The calculated DRG 194 is found by data processor 25 in a look-up table of allowable values in repository 17 and processor 25 determines that it has a 6.3 day average length of stay per episode of care and the payer organization will reimburse the provider for DRG 194 using a previously contacted amount of $10,000. Both the DRG LOS (Length of Stay) and reimbursement rate are assigned to a patient record and used to calculate estimated reimbursement. An objective for the healthcare organization is to treat the patient in less than 6.3 days and for less than $10,000, so that the healthcare organization may profitably keep the excess revenue. In contrast, if the treatment cost exceeds the contractual amount, the healthcare organization absorbs the additional costs and makes a loss.

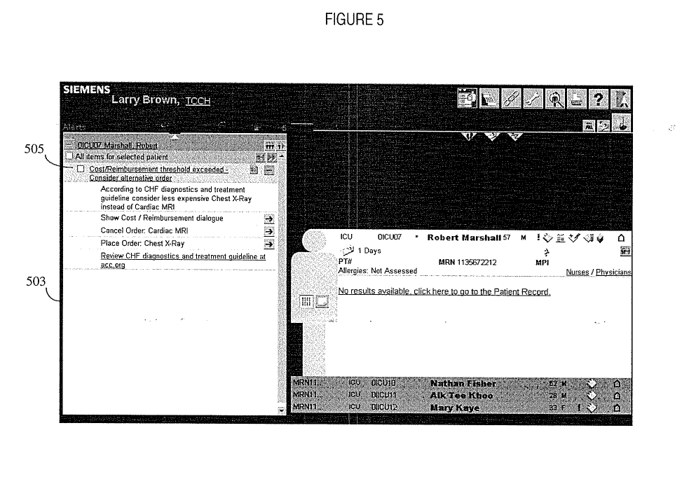

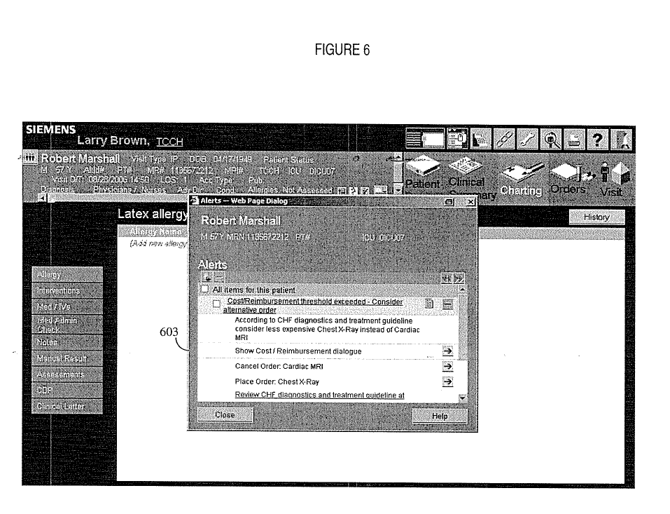

Further diagnostic services are ordered by an attending physician in step 419 including a Cardiac MRI, ECG and laboratory tests. In response to the attending physician placing and signing an order for the diagnostic services, real-time order data is populated by the Clinical Information System. This initiates the execution of workflow processor 39 (FIG. 1) in step 430. In response to the attending physician initiating the Cardiac MRI order, workflow processor 39 notifies the user of the Clinical Information System that a projected profit falls below a customizable profit threshold and suggests a more cost efficient diagnostic procedure, a chest X-Ray. The suggested alternative service complies with clinical guidelines for diagnosis and treatment of Congestive Heart Failure. FIG. 5 shows user interface display image 503 presenting a worklist of a worker indicating a notification message 505. Notification message 505 alerts a worker that the projected profit in performing the Cardiac MRI order, falls below a customizable profit threshold and suggests the more cost efficient chest X-Ray. FIG. 6 similarly shows user interface display image 603 illustrating the notification message in image window 603.

Continuing with FIG. 4, the worker in step 423 replaces the order for cardiac MRI with an order for chest X-Ray in two levels. The placement of the X-Ray order again initiates the execution of workflow processor 39 (FIG. 1) in step 430. This time workflow processor 39 does not recognize any negative impact on costs or detect that a projected profit falls below a customizable profit threshold. Hence, no notification message is sent to a user of the Clinical Information System by processor 39 and the ordered services are performed in step 425. In response to performing the services, congestive heart failure (CHF) is diagnosed. The patient is treated with beta-blockers, diuretics and ACE-inhibitors. Further, performing the services causes an update of cost-object 407. If further treatment for this patient is necessary, the updated cost-object information is immediately available for use by workflow processor 39 in performing step 430. After six days, the patient is discharged in step 427 and the cost-object is closed. The integration of workflow processor 39 with the clinical information system illustrated in the functional operation of FIG. 4 enables a hospital to increase profit by choosing a more cost-efficient alternative treatment (chest X-Ray instead of Cardiac MRI). Workflow processor 39 is readily integrated into an existing clinical workflow performed in a Clinical Information System.

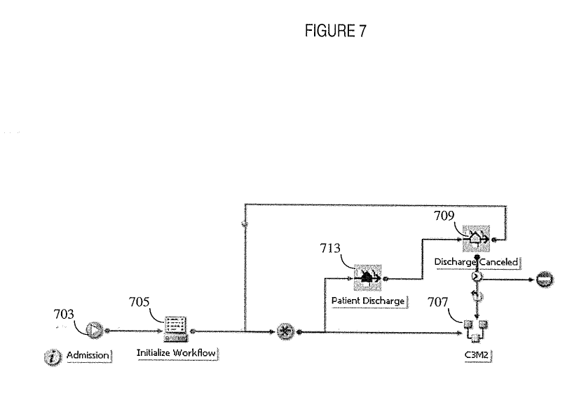

FIG. 7 illustrates integration of a cost based treatment selection system workflow task sequence 340 in a clinical workflow. Specifically, FIG. 7 shows an Admission, Discharge Transfer (ADT) workflow that starts with patient admission in step 703, initializes the ADT workflow parameters in step 705 and initiates execution of a new instance of a cost based treatment selection system workflow task sequence 340 in workflow processor 39 in step 707. Workflow process 340 is integrated as an additional sub-procedure, for example, that is initiated as a step in the ADT workflow following admission and prior to discharge of a patient in step 713. Discharge may be canceled for clinical reasons in step 709. Execution of workflow process 340 may also be triggered by a manual request, independent of an automated ADT workflow. In this case, the workflow is executed substantially immediately.

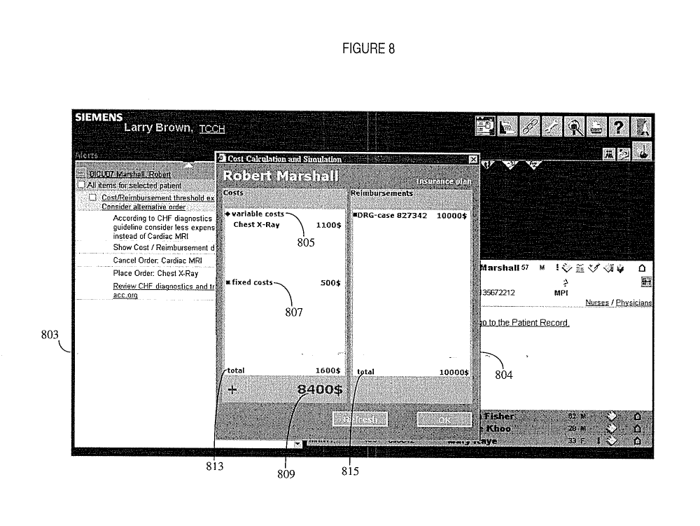

FIG. 8 shows user interface (UI) display image 803 presenting profit/loss data provided by workflow processor 39 (FIG. 1) executing workflow process 340 (FIG. 3) in image window 804 to a user of a Clinical Information System. Display image window 804 shows expected reimbursement 815 (e.g., for a working DRG) and the sum 813 of variable costs 805 and fixed costs 807 of one or more services performed on a patient. The display of variable costs is broken down according to performed services. Display image window 804 also shows the current profit/loss projection 809. Profitable projections are shown on the left hand side of window 804, highlighted in green. In contrast, a loss projection may be shown with the costs column on the right hand side of the reimbursement column and be highlighted in red.

Acquisition processor 15 (FIG. 1) automatically interrogates at least one information repository 17 for data concerning cost to a healthcare organization of providing a proposed treatment to a patient and expected cost reimbursement to the healthcare organization for the proposed treatment. Acquisition processor 15 initiates generation of at least one message, including a patient identifier and treatment identification code, for communication to at least one information repository 17, in response to data indicating occurrence of a treatment related event. The at least one information repository 17 identifies services (Service objects) that are further sub-divided into items. When an order for treatment is initiated acquisition processor 15 uses repository 17 to access an associated order item number and access an associated corresponding cost-object to validate the cost information. The cost-object contains items that have been ordered since the patient was admitted. Data processor 25 sums item costs so that next and subsequent orders are associated with data including DRG objects indicating items that have been ordered and costs expended in treating the patient.

A DRG object contains a list of DRG's individually associated with a specific grouping of medical diagnoses and an individual DRG further indicates estimated length of stay, expected amount for reimbursement, and a complexity factor. The amount for reimbursement includes monetary values and calculations for room & board, nursing care, ancillary tests, procedures, and supplies. The charge amount is more than cost amount and allows for a reasonable surplus. The cost amount comes from a cost accounting system through an automatic interface. The amount of reimbursement is calculated periodically by rate setting groups and may be modified for non-Medicare and non-Medicaid contracts based on specific contract terms developed between payer and healthcare provider organizations. Within a DRG object, diagnoses are grouped by major disease category that allow assignment of a DRG either automatically by evaluating primary diagnoses or manually by an individual, such as an admitting physician or attending physician. Acquisition processor 15 interrogates repository 17 using patient identification number schema, such that items that have been ordered for a patient for a current admission are available for use by an arithmetic summary function employed by data processor 25.

A DRG master object comprises a table with predefined DRG identifiers, DRG descriptions, average length of stay (ALOS), expected reimbursement amount ($xxx,xxx,xxx.xx), and other objects, such as classification by medical or surgical, MDC (major diagnosis category) and complexity factor/multiplier, for example. Cost information is added to a DRG object from interface processors that receive calculated values from a contract management system. Cost information is acquired from a cost accounting module and orderable treatment or service items comprise a discrete entry in the module so that, using known cost accounting methods, the cost of an item is calculated from direct and indirect expense categories attributed to the item. The cost of an item may be increased by a percentage or a fixed monetary amount to arrive at a charge amount. System 10 (FIG. 1) determines what cost information is to be acquired and the cost information is acquired in response to placing of an order. The calculation of the cost is done periodically by a healthcare organization when a reimbursement contract with a payer organization is changed. An item object cost and charge monetary amounts are determined by healthcare provider organization cost accountants using generally accepted cost accounting principles. The charge monetary amounts are periodically reviewed and changed based on a variety of internal (e.g. labor costs, vendor rate increases) and external economic conditions (e.g., payer organization contract changes).

Display processor 26 of system 10 provides a display image indicating accumulated costs per patient visit including a listing of general costs as well as itemized costs for performed services in real-time. Data processor 25 performs a calculation of profit or loss using a cost-object and the expected reimbursement and simulates the effect of ordering a treatment service on a cost-object and associated profit or loss of providing the treatment service. Workflow processor 39 escalates tasks in response to determining tasks are not completed within a predetermined time period and is extensible to other integration points of billing and clinical information. System 10 is implemented within a Hospital Information System in one embodiment and is supported by a Workflow Management System.

FIG. 9 shows a flowchart of a workflow process performed by cost based treatment selection system 10 (FIG. 1) providing a healthcare worker with patient specific treatment cost information during a treatment episode. In step 902 following the start at step 901, acquisition processor 15 automatically interrogates at least one information repository 17 for data indicating cost to a healthcare organization of providing multiple proposed treatments (including an individual treatment) to a patient and expected cost reimbursement to the healthcare organization for the proposed treatments by initiating generation of at least one message including a patient identifier and treatment identification code for communication to repository 17, in response to data indicating occurrence of a treatment related event. A treatment related event comprises at least one of, a change in level of care of the patient and a change in, or creation of, a treatment plan for the patient and entry of data indicating orders for the proposed treatments via a computerized treatment order entry system. In one example, the multiple proposed treatments are administered to the patient over an extended period comprising at least a week and data processor 25 cumulatively adds costs of the multiple proposed treatments as they are ordered.

The data indicating cost to the healthcare organization of providing a proposed treatment to a patient comprises Diagnosis Related Group data (including one or more, e.g., a list of DRG items) comprising estimated length of stay in a hospital and estimated reimbursement amount. The data indicating expected cost reimbursement to the healthcare organization for a proposed treatment comprises a charge amount representing a cost to the healthcare organization of providing the proposed treatment plus a profit amount.

In step 904, data processor 25 calculates expected profit or loss of the proposed treatments (which may comprise one or more proposed treatments) by subtracting an accumulated total of the costs of the proposed treatments from an accumulated total of the expected cost reimbursements. Data processor 25 calculates expected profit or loss of the treatments for a patient visit to a healthcare organization to determine expected profit or loss of the visit. Workflow processor 39, in step 907 identifies alternative treatments in response to diagnosis representative data. Specifically, workflow processor 39 identifies the alternative treatments in response to one or more of, entry of data indicating a proposed treatment via a computerized treatment order entry system and laboratory test result data. In step 914, display processor 26 initiates generation of data representing at least one display image including information indicating the multiple proposed treatments are unprofitable for the healthcare organization in response to acquired data indicating cost of proposed treatments and expected cost reimbursements. The at least one display image includes information indicating the alternative treatments to the proposed treatment which are more profitable for the healthcare organization. Further, information indicating a proposed treatment is unprofitable for the healthcare organization is presented in a composite image together with data identifying a treatment order for the proposed treatment provided by a computerized order entry system. The at least one display image also includes information indicating both fixed and variable cost elements of cost of a proposed treatment. The process of FIG. 9 terminates at step 921.

The systems and processes of FIGS. 1-9 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. The system provides accumulated and individual treatment item cost information to generate profitability parameters used to influence treatment decisions made by a clinical user in patient treatment. The processes and applications may in alternative embodiments, be located on one or more (e.g., distributed) processing devices accessing a network linking the elements of FIG. 1. Further, any of the functions and steps provided in FIGS. 1-9 may be implemented in hardware, software or a combination of both and may reside on one or more processing devices located at any location of a network linking the elements of FIG. 1 or another linked network including the Internet.

What is claimed is:

1. A system enabling cost based treatment selection by providing a healthcare worker with patient specific treatment cost information during a treatment episode, comprising:
an acquisition processor for automatically interrogating at least one information repository for data indicating cost to a healthcare organization of providing a Proposed treatment to a patient and expected cost reimbursement to said healthcare organization for said proposed treatment by initiating generation of at least one message including a patient identifier and treatment identification code for communication to said at least one information repository, in response to data indicating occurrence of a treatment related event; and
a display processor for initiating generation of data representing at least one display image including information indicating said proposed treatment is unprofitable for said healthcare organization in response to acquired data indicating cost of proposed treatment and expected cost reimbursement.

2. The system according to claim 1, including
a data processor for calculating expected profit or loss of said proposed treatment by subtracting said cost of proposed treatment from said expected cost reimbursement.

3. The system according to claim 1, wherein
said acquisition processor automatically interrogates said at least one information repository for data indicating cost to a healthcare organization of providing a plurality of treatments to said patient and corresponding expected cost reimbursement to said healthcare organization for said treatments by initiating generation of at least one message including a patient identifier and treatment identification codes for communication to said at least one information repository.

4. The system according to claim 3, including
a data processor for calculating expected profit or loss of said treatments by subtracting said cost of proposed treatment from said expected cost reimbursement.

5. The system according to claim 3, including
a data processor for calculating expected profit or loss of said treatments by subtracting a total of accumulated cost of said plurality of treatments from a total of accumulated corresponding expected cost reimbursements.

6. The system according to claim 5, wherein
said plurality of treatments are administered to said patient over an extended period comprising at least a week.

7. The system according to claim 5, wherein
said data processor cumulatively adds costs of said plurality of treatments as they are ordered.

8. The system according to claim 4, wherein
said data processor calculates expected profit or loss of said treatments for a patient visit to a healthcare organization to determine expected profit or loss of said visit.

9. The system according to claim 1, wherein
said treatment related event comprises entry of data indicating said proposed treatment via a computerized treatment order entry system and
said information indicating said proposed treatment is unprofitable for said healthcare organization is presented in a composite image together with data identifying a treatment order for said proposed treatment provided by said computerized order entry system.

10. The system according to claim 1, wherein
said treatment related event comprises at least one of, (a) a change in level of care of said patient and (b) a change in, or creation of, a treatment plan for said patient.

11. The system according to claim 1, wherein
said data indicating cost to said healthcare organization of providing said proposed treatment to a patient comprises Diagnosis Related Group data comprising estimated length of stay in a hospital and estimated reimbursement amount.

12. The system according to claim 11, wherein
said data indicating cost to said healthcare organization of providing said proposed treatment to a patient comprises a list of Diagnosis Related Group data items.

13. The system according to claim 11, wherein
said data indicating expected cost reimbursement to said healthcare organization for said proposed treatment comprises a charge amount representing said cost to said healthcare organization of providing said proposed treatment plus a profit amount.

14. The system according to claim 1, wherein
said at least one display image includes information indicating both fixed and variable cost elements of cost of said proposed treatment.

15. A system enabling cost based treatment selection by providing a healthcare worker with patient specific treatment cost information during a treatment episode, comprising:
an acquisition processor for automatically interrogating at least one information repository for data indicating cost to a healthcare organization of providing a proposed treatment to a patient and expected cost reimbursement to said healthcare organization for said proposed treatment by initiating generation of at least one message including a patient identifier and treatment identification code for communication to said at least one information repository, in response to entry of data indicating an order for said proposed treatment via a computerized treatment order entry system;
a data processor for calculating expected profit or loss of said proposed treatment by subtracting said cost of proposed treatment from said expected cost reimbursement; and
a display processor for initiating generation of data representing at least one display image including information indicating alternative treatments to said proposed treatment, said alternative treatments being more profitable for said healthcare organization in response to acquired data indicating cost of proposed treatment and expected cost reimbursement.

16. The system according to claim 15, including
a workflow processor for identifying said alternative treatments in response to diagnosis representative data.

17. The system according to claim 15, wherein
said workflow processor identifies said alternative treatments in response to at least one of, (a) entry of data indicating said proposed treatment via a computerized treatment order entry, system and (b) laboratory test result data.

18. A system enabling cost based treatment selection by providing a healthcare worker with patient specific treatment cost information during a treatment episode, comprising:
an acquisition processor for automatically interrogating at least one information repository for data indicating cost to a healthcare organization of providing a plurality of proposed treatments to a patient and expected cost reimbursement to said healthcare organization for said proposed treatments by initiating generation of at least one message including a patient identifier and treatment identification code for communication to said at least one information repository, in response to entry of data indicating orders for said proposed treatments via a computerized treatment order entry system;
a data processor for calculating expected profit or loss of said proposed treatments by subtracting an accumulated total of said costs of said proposed treatments from an accumulated total of said expected cost reimbursements; and
a display processor for initiating generation of data representing at least one display image including information indicating said plurality of proposed treatments are unprofitable for said healthcare organization in response to acquired data indicating cost of proposed treatments and expected cost reimbursements.
